(19) United States
(12) Patent Application Publication
(10) Pub. No.: US 2006/0143321 A1
(43) Pub. Date: Jun. 29, 2006

(54) Apparatus and method for managing peripheral device using auto-generated metadata

(75) Inventor: Jun-Ho Yoon, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/290,443

(22) Filed: Dec. 1, 2005

(30) Foreign Application Priority Data
Dec. 10, 2004 (KR) 2004-0104148

(51) Int. Cl. G06F 3/00

(52) U.S. Cl. 710/8

(57) ABSTRACT

A peripheral device managing apparatus using auto-generated metadata and method of using the same are provided. The peripheral device managing apparatus includes a plurality of peripheral devices for generating execution data by executing a function of the peripheral device, and generating metadata which includes identification information of the execution data, a plurality of peripheral device controlling units for respectively controlling the peripheral devices through a network, and generating management data by adding the metadata to the execution data, and a peripheral device managing unit for storing the generated management data, and retrieving management data which meets a predetermined search condition out of the management data. Accordingly, a plurality of peripheral devices and a plurality of peripheral device controlling units can be efficiently managed.

### CROSS-REFERENCE TO RELATED APPLICATION

This application claims the benefit under 35 U.S.C. §119(a) of a Korean Patent Application No. 10-2004-0104148, filed on Dec. 10, 2004, in the Korean Intellectual Property Office, the entire disclosure of which is hereby incorporated by reference.

### BACKGROUND OF THE INVENTION

1. Field of the Invention

The present invention relates to an apparatus and method of managing peripheral devices. More particularly, the present invention relates to an apparatus and method of managing peripheral devices using metadata auto-generated in each of the peripheral devices, from management data to which execution data obtained by executing a function of the peripheral device is added.

2. Description of the Related Art

A document management system (DMS) becomes popular for storing and managing a large number of electronic documents by digitizing original documents.

Document data which is digitized from original documents and managed by a DMS may be data to be output by an image forming apparatus like a printer, or data to be input by an inputting apparatus such as a scanner.

When using the DMS, peripheral devices such as printers and scanners can be efficiently managed.

FIG. 1 is a schematic diagram illustrating a conventional peripheral device managing apparatus. The conventional peripheral device managing apparatus comprises a user terminal 110, an image forming apparatus 120, and a manager terminal 130. There may be several user terminals and image forming apparatuses included in the peripheral device managing apparatus. The user terminal 110 and the image forming apparatus 120 are connected to a network. The peripheral device managing apparatus shown in FIG. 1 may be referred to as an output side peripheral device managing apparatus.

The user terminal 110 generates predetermined document data and controls the image forming apparatus 120 connected to the network. The image forming apparatus 120 outputs the generated document data. The document data generated by the user terminal 110 is digitized document data.

The user terminal 110 embeds identification information of the image forming apparatus 120, which will output document data, into the document data to be output. At this time, the document data in which the identification information of the image forming apparatus 120 is embedded is stored in the manager terminal 130.

As a result, by using the document data stored in the manager terminal 130, a manager for managing the plurality of image forming apparatuses can determine how each of the image forming apparatuses is used. For example, a manager of a corporation can easily determine how frequently each image forming apparatus is used, and use this information to rearrange all image forming apparatuses connected.

That is, the manager managing a plurality of peripheral devices connected to a network can easily manage a plurality of peripheral output devices by using a conventional peripheral device managing apparatus. However, the conventional peripheral device managing apparatus cannot manage a plurality of peripheral input devices like scanners.

Further, in the conventional peripheral device managing apparatus, a user of a peripheral device should store identification information regarding each of the peripheral devices in a manager terminal. Moreover, the conventional peripheral device managing apparatus uses only identification information to manage the peripheral device, and does not manage information about the users, and therefore, the user cannot determine information about how each user uses the peripheral devices.

### SUMMARY OF THE INVENTION

An object of the present invention is to provide a peripheral device managing apparatus for managing a plurality of peripheral devices connected to a network by using auto-generated metadata comprising identification information of a peripheral device and identification information of a user of the peripheral device.

Another object of the present invention is to provide a peripheral device managing method of managing a plurality of peripheral devices connected to a network by using auto-generated metadata comprising identification information of a peripheral device and identification information of a user of the peripheral device.

Still another object of the present invention is to provide a computer readable recording medium for storing a program for managing a plurality of peripheral devices on a network by using metadata comprising identification information of a peripheral device and identification information of a user of the peripheral device.

According to an aspect of the present invention, an apparatus for managing a peripheral device is provided. The apparatus comprises a plurality of peripheral devices for generating execution data by executing a function of the peripheral device, and generating metadata which comprises identification information of the execution data, a plurality of peripheral device controlling units for respectively controlling the peripheral devices through a network, and generating management data by adding the metadata to the execution data, and a peripheral device managing unit for storing the generated management data, and retrieving management data which meets a predetermined search condition out of the management data.

Each of the peripheral devices may comprise a specific executing unit for generating execution data by executing a function of the peripheral device according to control of the peripheral device controlling unit, and a metadata generating unit for generating metadata which comprises identification information of the execution data.

Each of the peripheral devices may further comprise a peripheral device information storing unit for storing identification information of the peripheral device as identification information of the execution data, and the metadata generating unit for retrieving the identification information of the peripheral device out of the peripheral device information storing unit and generating metadata which comprises the retrieved identification information.

The metadata generating unit may generate metadata which comprises information about the time when the function executing unit operated as the identification information of the execution data.

The peripheral device controlling unit may comprise a first user interface unit for providing a user interface allowing a user of the peripheral device to input identification information of the user, and a management data generating unit for generating metadata which comprises identification information of the user of the peripheral device and identification information of the execution data, and generating management data by adding the generated metadata to the execution data.

The peripheral device managing unit may comprise a management data storing unit for storing the management data, a second user interface unit for receiving a predetermined search condition, and a management data searching unit for retrieving management data which comprises metadata meeting the search condition out of the management data storing unit.

The second user interface unit may display identification information included in metadata of the retrieved management data.

The function of the peripheral devices may comprise a scan function.

According to another aspect of the present invention, an apparatus for managing a peripheral device is provided. The apparatus comprises a plurality of peripheral devices for generating execution data by executing a function of the peripheral device, generating metadata which comprises identification information of the execution data, generating management data by adding the metadata to the execution data, and storing the management data, a plurality of peripheral device controlling units that generate predetermined control signals to control the peripheral devices and are connected to the peripheral devices through a network, and a peripheral device managing unit that is connected to the peripheral devices through a network and retrieves management data which meets an input predetermined search condition out of the management data.

Each of the peripheral devices may comprise a function executing unit for executing the function of the peripheral device according to the control signal, a peripheral device information storing unit for storing identification information of the peripheral device, an information retrieving unit for retrieving the identification information of the peripheral device controlling unit from the control signal, a metadata generating unit for retrieving the identification information of the peripheral device out of the peripheral device information storing unit, and generating metadata which comprises the retrieved identification information of the peripheral device and the retrieved identification information of the peripheral device controlling unit; and a management data generating unit for generating management data by adding the metadata to the execution data.

According to still another aspect of the present invention, a method for managing a peripheral device is provided device. The method comprises generating execution data by executing a function of a peripheral device and generating metadata which comprises identification information of the execution data, generating management data by adding the metadata to the execution data, storing the generated management data, and receiving a predetermined search condition and reading management data which meets the predetermined search condition out of the stored management data.

According to yet another aspect of the present invention, a computer readable recording medium having embodied thereon a computer program for executing is provided. The computer readable recording medium comprises a first set of computer instructions for generating execution data by executing a function of a peripheral device and generating metadata which comprises identification information of the execution data, a second set of computer instructions for generating management data by adding the metadata to the execution data, a third set of computer instructions for storing the generated management data, and a forth set of computer instructions for receiving a predetermined search condition and retrieving management data which meets the predetermined search condition out of the stored management data.

### BRIEF DESCRIPTION OF THE DRAWINGS

The above and other features and advantages of the present invention will become more apparent by describing in detail exemplary embodiments thereof with reference to the accompanying drawings in which:

FIG. 1 is a schematic diagram illustrating a conventional peripheral device managing apparatus;

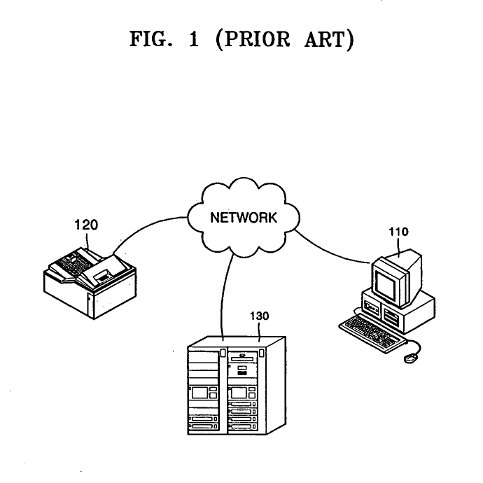

FIG. 2 is a schematic diagram illustrating a peripheral device managing apparatus using auto-generated metadata according to an exemplary embodiment of the present invention;

FIG. 3 is a block diagram illustrating the peripheral device managing apparatus using auto-generated metadata illustrated in FIG. 2;

FIG. 4 is a block diagram illustrating a peripheral device managing apparatus using auto-generated metadata according to an exemplary embodiment of the present invention; and

FIG. 5 is a flowchart illustrating a peripheral device managing method using auto-generated metadata according to an exemplary embodiment of the present invention.

Throughout the-drawings, like reference numerals will be understood to refer to like parts, components and structures.

### DETAILED DESCRIPTION OF EXEMPLARY EMBODIMENTS

An apparatus and method for managing peripheral devices using auto-generated metadata according to exemplary embodiments of the present invention will now be described in greater detail with reference to the accompanying drawings, in which exemplary embodiments of the invention are shown.

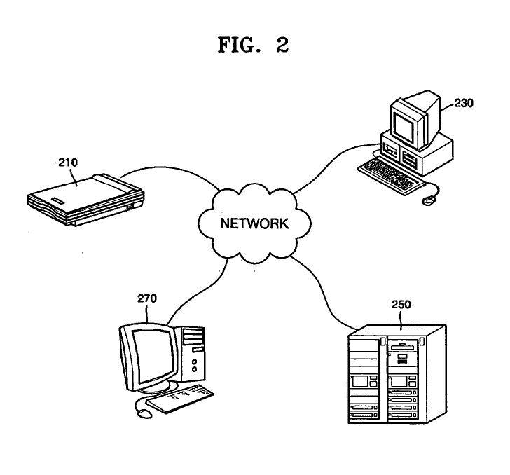

FIG. 2 is a schematic diagram illustrating a peripheral device managing apparatus using auto-generated metadata according to an exemplary embodiment of the present invention. The peripheral device managing apparatus comprises a peripheral device 210, a peripheral device controlling unit 230, a peripheral device managing unit 250, and a manager terminal 270.

A plurality of peripheral devices 210 and a plurality of peripheral device controlling units 230 can be connected to the network. The peripheral device 210 may be a peripheral input device for inputting data or a peripheral output device for outputting data. For example, the peripheral device 210 may be a peripheral input device having a scan function, and in this case, the peripheral device managing apparatus according to an exemplary embodiment manages peripheral devices on the input side.

The peripheral device 210 is used by unspecified users. Each user of the peripheral device 210 may use his/her own peripheral device controlling unit 230, or a plurality of users may share the peripheral device controlling unit 230.

The peripheral device managing unit 250 may be connected to a network to which the peripheral device 210 and peripheral device controlling unit 230 are connected, or may be directly connected to all the plurality of peripheral controlling units 230. There may be a single peripheral device managing unit 250 is present in the peripheral device managing apparatus according to an exemplary embodiment.

A manager manages the plurality of peripheral devices by controlling the arrangement of the plurality of peripheral devices and the operating time of each of the peripheral devices 210 using data output from the peripheral device managing unit 250. The manager can check the data output from the peripheral device managing unit 250 by using the manager terminal 270.

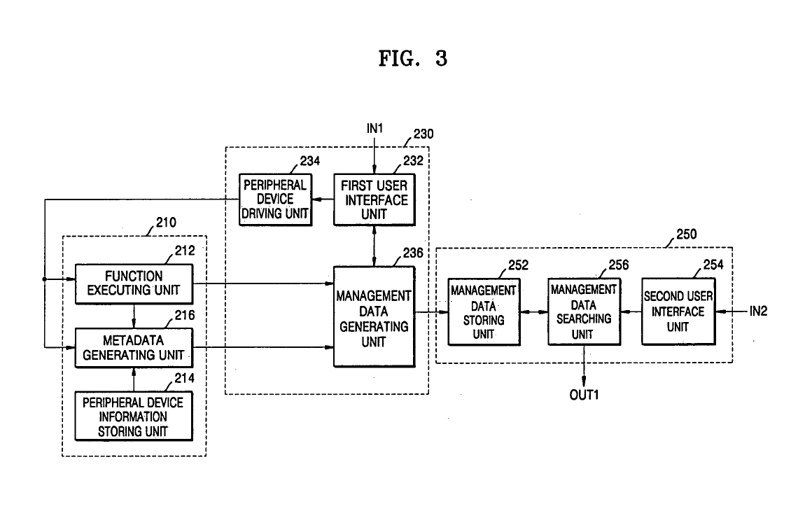

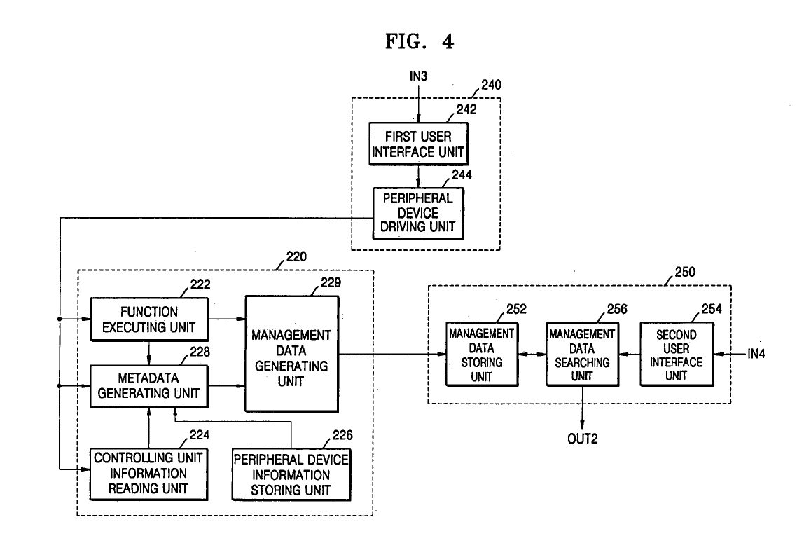

The operation of each of the peripheral device 210, the peripheral device controlling unit 230 and the peripheral device managing unit 250 will now be described in greater detail with reference to FIGS. 3 and 4.

FIG. 3 is a block diagram illustrating the peripheral device managing apparatus using auto-generated metadata illustrated in FIG. 2.

Referring to FIG. 3, the peripheral device 210 comprises a function executing unit 212, a peripheral device information storing unit 214 and a metadata generating unit 216. The peripheral device 210 generates metadata comprising its identification information and execution data which is obtained by executing its function.

The function executing unit 212 executes the function of the peripheral device 210 according to the control of the peripheral device controlling unit 230. The data obtained through the operation of the function executing unit 212 is referred to as the execution data. For example, if the peripheral device 210 is a scanner, the function executing unit 212 scans a predetermined document and outputs scanned data, and in this case, the scanned data is the execution data. Similarly, if the peripheral device 210 is a multifunctional device having a scan function and the function executing unit 212 operates according to a scan command from the peripheral device controlling unit 230, the function executing unit 212 outputs scanned data as the execution data.

The peripheral device information storing unit 214 stores identification information of the peripheral device 210. The identification information of the peripheral device 210 comprises at least one of information about the type of the peripheral device 210, such as a product name, and location information of the peripheral device 210 on the network.

The metadata generating unit 216 operates according to the control of the peripheral device controlling unit 230 and generates predetermined metadata. The metadata is data for indexing the execution data output by the function executing unit 212. More specifically, the metadata comprises identification information of the peripheral device 210 or information about the time when the function executing unit 212 operated. The identification information of the peripheral device 210 is retrieved from the peripheral device information storing unit 214 through firmware installed in the peripheral device 210 and transmitted to the metadata generating unit 216. The information about the time when the function executing unit 212 operated is transmitted from the function executing unit 212 to the metadata generating unit 216.

The peripheral device controlling unit 230 comprises a first user interface unit 232, a peripheral device driving unit 234 and a management data generating unit 236. The peripheral device controlling unit 230 controls the peripheral device 210, is connected to the network, and generates management data by adding the metadata to the execution data.

The first user interface unit 232 receives predetermined data from a peripheral device user. The peripheral device driving unit 234 drives the function executing unit 212 and the metadata generating unit 216 according to a user input. The peripheral device user may be a user of the peripheral device 210 or a user of the peripheral device controlling unit 230.

The management data generating unit 236 adds the identification information of the peripheral device user to the identification information included in the metadata generated by the metadata generating unit 216. The identification information of the peripheral device user is input through the first user interface unit 232 and recognized by the management data generating unit 236, which adds the identification information of the peripheral device user to the metadata. Therefore, an input signal IN1 may be a signal input by the peripheral device user for instructing the peripheral device driving unit 234 to operate, or identification information of the peripheral device user which the user intends to be recognized by the management data generating unit 236.

The management data generating unit 236 generates the management data by adding the metadata to the execution data output from the function executing unit 212. The metadata added to the execution data can comprise various identification information as described above. That is, the identification information included in the metadata comprises identification information of the peripheral device user which is input by the peripheral device user through the first user interface unit 232 as well as the identification information of the peripheral device 210 and information about the time when the function executing unit 212 operated, each of which is generated by the metadata generating unit 216.

The peripheral device managing unit 250 comprises a management data storing unit 252, a second user interface unit 254 and a management data searching unit 256. Further, the peripheral device managing unit 250 stores generated management data in a database, and retrieves management data meeting a predetermined search condition from the stored management data.

The management data storing unit 252 stores the management data generated by the management data generating unit 236 in a database. That is, the management data searching unit 256 receives a predetermined search condition through the second user interface unit 254, and retrieves management data meeting the received search condition from the management data stored in the management data storing unit 252.

An input signal IN2 may be a predetermined search condition input from the outside, or a signal for controlling the operation of the management data searching unit 256. Meanwhile, an output signal OUT1 may be management data retrieved from the management data storing unit 252 by the management data searching unit 256, or identification information included in the retrieved management data.

The search condition input to the second user interface unit 254 may specify a category of the identification information included in the metadata. That is, the search condition may define the identification information of the peripheral device 210, the information about the time when the function executing unit 212 operated, or the identification information of the peripheral device user.

For instance, assuming that a company is located in a six-story building and has one hundred staff members, each of which uses a computer, a total of 20 scanners are connected to a network in the company, and each of the computers is connected to all the 20 scanners through the network, the staff refers to the user, the scanner refers to the peripheral device 210, and the computer refers to the peripheral device controlling unit 230.

The metadata of the management data generated by management data generating unit 236 is present in all execution data. The execution data is data scanned by the scanner. Assuming that one staff member (hereinafter referred to as A) of the one hundred staff members receives data scanned by a scanner located in a hall on the fifth floor and performs a predetermined graphic operation with his/her computer by using the scanned data, the identification information included in the metadata of the management data generated by the management data generating unit 236 may comprise identification information of the scanner located in the hall on the fifth floor, the time when the scanner operated, and identification information of the computer which controlled the operation of the scanner. The identification information of the scanner may be information indicating that the scanner is located in the hall on the fifth floor or information indicating the type of the scanner. Further, the identification information of the computer may be information about the computer of ‘A’ or information about ‘A’.

In this way, the management data storing unit 252 can store a large amount of management data. The manager can obtain desired management data from the management data storing unit 252 by inputting a predetermined search condition. For example, when the manger specifies a search restricted to all scanners in a meeting room on a third floor which operated from February 1 to March 1, management data retrieved by the management data searching unit 256 can comprise information about the frequency of use of all the scanners in the meeting room on the third floor. Accordingly, the manager may move a scanner which is used relatively little to another floor, and thus can more efficiently manage the peripheral devices.

As another example, the manager may instruct the management data searching unit 256 to retrieve all management data comprising data scanned by a scanner used by ‘A’ from February 1 to March 1 from the management data stored in the management data storing unit 252. In this case, the management data retrieved by the management data searching unit 256 comprises information about the scanner that ‘A’ most frequently used among the 20 scanners, and the manager may change the location of the scanner according to the information.

Meanwhile, according to an exemplary embodiment of the present invention, the management data generating unit 236 included in the peripheral device controlling unit 230 in FIG. 3 can also be included in the peripheral device managing unit 250.

FIG. 4 is a block diagram illustrating a peripheral device managing apparatus using auto-generated metadata according to an exemplary embodiment of the present invention. A function executing unit 222, a peripheral device information storing unit 226 and a peripheral device driving unit 244 perform the same operations as the function executing unit 212, the peripheral device information storing unit 216 and the peripheral device driving unit 234, respectively, and an input signal IN4 and an output signal OUT2 are identical to the input signal IN2 and the output signal OUT1.

A metadata generating unit 228 generates metadata comprising information about the time when the function executing unit 222 operated, identification information of a peripheral device 220 which is retrieved from a peripheral device information storing unit 226, and identification information of a peripheral device controlling unit 240. In FIG. 3, the identification information of the peripheral device controlling unit 230 is added to the metadata previously generated by the metadata generating unit 216, but in FIG. 4, the identification information of the peripheral device controlling unit 240 is already included in metadata generated by the metadata generating unit 228. To this end, the identification information of the peripheral controlling unit 240 is transmitted to the metadata generating unit 228 by an information retrieving unit 224.

A first user interface unit 242 receives an operating instruction of the peripheral device controlling unit 240 by a peripheral device user's input, and the peripheral device driving unit 244 instructs the function executing unit 222 and the metadata generating unit 228 to operate. The peripheral device user may be a user of the peripheral device 220 or a user of the peripheral device controlling unit 240.

However, in FIG. 4, since the peripheral device 220 generates the metadata comprising the identification information of the peripheral device controlling unit 240, an input signal IN3 may be a signal comprising instructions for the operation of the peripheral device driving unit 244 input by the peripheral device user.

The peripheral device driving unit 244 drives the function executing unit 222 and the metadata generating unit 228. Also, the peripheral device driving unit 244 drives the controlling unit information reading unit 224 to retrieve the identification information of the peripheral device controlling unit 240. The identification information of the peripheral device controlling unit 240 may be identification information of the peripheral device controlling unit 240 implemented as hardware, or the location of the peripheral device controlling unit 240 on a network. The location on a network may be preferably an IP address of the peripheral device controlling unit 240 on a network. In the mean time, if a user is limited to using only one of a plurality of available peripheral device controlling units 240, the identification information of the peripheral device controlling unit 240 can also be the identification information of the peripheral device user. The metadata generating unit 228 generates metadata comprising identification information retrieved by the information retrieving unit 224.

According to exemplary embodiments of the present invention, a management data storing unit 262 may be included in the peripheral device 220, in the peripheral device controlling unit 240, or in a peripheral device managing unit 260.

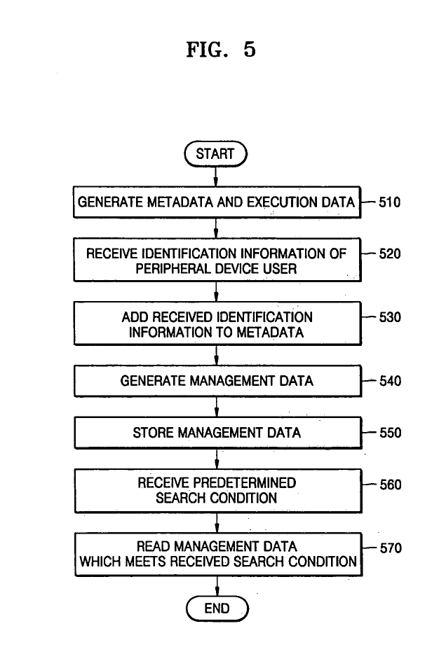

FIG. 5 is a flowchart illustrating a peripheral device managing method using auto-generated metadata according to an exemplary embodiment of the present invention. Referring to FIG. 5, the peripheral device managing method comprises operations of generating metadata and execution data and generating management data at steps 510 through 540, and steps of storing the management data and retrieving management data which meets a predetermined search condition at steps 550 through 570.

According to the control of the peripheral device driving unit 234, the function executing unit 212 and the metadata generating unit 216 of the peripheral device 210 generate the execution data and the metadata, respectively at step 510.

The management data generating unit 236 receives identification information of a peripheral device user which is input through the first user interface unit 232 at step 520, and adds the received identification information of the peripheral device user to provided identification information of the metadata at step 530.

The management data generating unit 236 generates the management data by adding the metadata comprising the identification information of the peripheral device user to the execution data at step 540.

The management data storing unit 252 stores the management data generated by the management data generating unit 236 at step 550.

A manager inputs a predetermined search condition through the second user interface unit 254 at step 560 and instructs the management data searching unit 256 to retrieve management data which meets the search condition from the management data stored the management data storing unit 252. As the result, the management data searching unit 256 retrieves the management data meeting the search condition at step 570. More specifically, the management data searching unit 256 can display identification information included in metadata of the management data which meets the search condition, in a predetermined report form through the second user interface unit 254.

Exemplary embodiments of the invention can also be implemented as computer readable code on a computer readable recording medium. The computer readable recording medium is any data storage device that can store data which can be thereafter read by a computer system. Examples of the computer readable recording medium comprise read-only memory (ROM), random-access memory (RAM), Compact Disc Read Only Memory (CD-ROM), magnetic tapes, floppy disks, optical data storage devices, and carrier waves such as data transmission through the Internet. The computer readable recording medium can also be distributed over network coupled computer systems so that the computer readable code is stored and executed in a distributed fashion. Also, functional programs, code, and code segments for accomplishing exemplary embodiments of the present invention can be easily construed by programmers skilled in the art to which the present invention pertains.

As describe above, according to the present invention, a peripheral device managing apparatus using auto-generated metadata and a method of using the same allow a manager to efficiently manage a plurality of peripheral devices and a plurality of peripheral device controlling units.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A peripheral device managing apparatus comprising:
a plurality of peripheral devices for generating execution data by executing a function of the peripheral device, and generating metadata which comprises identification information of the execution data;
a plurality of peripheral device controlling units for respectively controlling the peripheral devices through a network, and generating management data by adding the metadata to the execution data; and
a peripheral device managing unit for storing the generated management data, and retrieving management data which meets a predetermined search condition out of the management data.

2. The peripheral device managing apparatus of claim 1, wherein each of the peripheral devices comprises:
a specific executing unit for generating execution data by executing a function of the peripheral device according to control of the peripheral device controlling unit; and
a metadata generating unit for generating metadata which comprises identification information of the execution data.

3. The peripheral device managing apparatus of claim 2, wherein each of the peripheral devices further comprises:
a peripheral device information storing unit for storing identification information of the peripheral device as identification information of the execution data, and
the metadata generating unit for retrieving the identification information of the peripheral device out of the peripheral device information storing unit and generates metadata which comprises the retrieved identification information.

4. The peripheral device managing apparatus of claim 2, wherein the metadata generating unit generates metadata which comprises information about the time when the function executing unit is operated as the identification information of the execution data.

5. The peripheral device managing apparatus of claim 1, wherein the peripheral device controlling unit comprises:
a first user interface unit for providing a user interface allowing a user of the peripheral device to input identification information of the user; and
a management data generating unit for generating metadata which comprises identification information of the user of the peripheral device and identification information of the execution data, and generating management data by adding the generated metadata to the execution data.

6. The peripheral device managing apparatus of claim 1, wherein the peripheral device managing unit comprises:
a management data storing unit for storing the management data;
a second user interface unit for receiving a predetermined search condition; and
a management data searching unit for retrieving management data which comprises metadata meeting the search condition out of the management data storing unit.

7. The peripheral device managing apparatus of claim 6, wherein the second user interface unit displays identification information included in metadata of the retrieved management data.

8. The peripheral device managing apparatus of claim 1, wherein the function of the peripheral devices comprises a scan function.

9. A peripheral device managing apparatus comprising:
a plurality of peripheral devices for generating execution data by executing a function of the peripheral device, generating metadata which comprises identification information of the execution data, generating management data by adding the metadata to the execution data, and storing the management data;
a plurality of peripheral device controlling units for generating predetermined control signals to control the peripheral devices and are connected to the peripheral devices through a network; and
a peripheral device managing unit connected to the peripheral devices through a network for retrieving management data which meets an input predetermined search condition out of the management data.

10. The peripheral device management apparatus of claim 9, wherein the control signal comprises identification information of the peripheral device controlling unit.

11. The peripheral device managing apparatus of claim 10, wherein the identification information of the peripheral device controlling unit comprises the address of the peripheral device controlling unit on the network.

12. The peripheral device managing apparatus of claim 9, wherein each of the peripheral devices comprises:
a function executing unit for executing the function of the peripheral device according to the control signal;
a peripheral device information storing unit for storing identification information of the peripheral device;
an information retrieving unit for retrieving the identification information of the peripheral device controlling unit out of the control signal;
a metadata generating unit for retrieving the identification information of the peripheral device out of the peripheral device information storing unit, and generating metadata which comprises the retrieved identification information of the peripheral device and the retrieved identification information of the peripheral device controlling unit; and
a management data generating unit for generating management data by adding the metadata to the execution data.

13. The peripheral device managing apparatus of claim 12, wherein the metadata generating unit generates metadata comprising identification information of the execution data which comprises at least one of the identification information of the peripheral device controlling unit, identification information of the peripheral device in which the metadata is generated, and information about the time when the function executing unit operated.

14. The peripheral device managing apparatus of claim 9, wherein the function of the peripheral devices comprises a scan function.

15. A peripheral device managing method comprising:
generating execution data by executing a function of a peripheral device and generating metadata which comprises identification information of the execution data;
generating management data by adding the metadata to the execution data;
storing the generated management data; and
receiving a predetermined search condition and retrieving management data which meets the predetermined search condition out of the stored management data.

16. The peripheral device managing method of claim 15, wherein the generating of the management data comprises:
receiving identification information from a user of the peripheral device;
generating metadata which comprises the received identification information and the identification information of the execution data; and
generating management data by adding the generated metadata to the execution data.

17. The peripheral device managing method of claim 15, wherein the retrieving of the management data comprises displaying the identification information included in the metadata of the retrieved management data.

18. A computer readable recording medium having embodied thereon a computer program for executing a peripheral device managing comprising:
a first set of computer instructions for generating execution data by executing a function of a peripheral device and generating metadata which comprises identification information of the execution data;
a second set of computer instructions for generating management data by adding the metadata to the execution data;
a third set of computer instructions for storing the generated management data; and
a forth set of computer instructions for receiving a predetermined search condition and reading management data which meets the predetermined search condition out of the stored management data.
